(19) United States
(12) Patent Application Publication
(10) Pub. No.: US 2004/0107218 A1
(43) Pub. Date: Jun. 3, 2004

(54) Distributed system and method for displaying and editing medically relevant data objects

(76) Inventors: Gerold Herold, Erlangen (DE); Tamas Ruzsics, Vemend (HU)

Correspondence Address: HARNESS, DICKEY & PIERCE, P.L.C., P.O.BOX 8910, RESTON, VA, 20195, US

(21) Appl. No.: 10/645,500

(22) Filed: Aug. 22, 2003

(30) Foreign Application Priority Data
Aug. 22, 2002 (DE) 10238596.3

(51) Int. Cl. G06F 17/00

(52) U.S. Cl. 707/104.1

(57) ABSTRACT

A data processing system is for processing medically relevant data objects including image data and/or metadata. The system has a first electronic data processing device for viewing and editing the data objects and has a data store and a first interface for outputting data objects. It has a second electronic data processing device for presenting data from data objects in medically relevant reports using report masks, the second electronic data processing device having a mask memory for storing the report masks and having a second interface for receiving the data objects. The first data processing device uses firmly prescribed data formats which the user cannot alter, while the second data processing device uses report masks, which the user can generate and/or alter even without knowledge of the syntax of the data objects, in order to present data from data objects. The interfaces on the first and second data processing devices can be connected to one another in order to transfer data objects from the first data processing device to the second data processing device.

The present application hereby claims priority under 35 U.S.C. § 119 on German patent application number DE 10238596.3 filed Aug. 22, 2002, the entire contents of which are hereby incorporated herein by reference.

### FIELD OF THE INVENTION

The invention generally relates to a distributed system and a method for displaying and editing medically relevant data objects.

### BACKGROUND OF THE INVENTION

The health sector is making increasing use of electronic patient records. These contain details relating to the patient's identity and can store not only information relating to current medication and to current findings but also the pathogenesis and the patient history. Electronic patient records can show all the information from conventional paper records and also have the known advantages of electronic records, such as outstanding portability and availability. In the medical sector, data objects permitting simultaneous storage of image data and metadata have recently been increasingly implemented for electronic patient records.

Examples of such data objects are the DICOM standard and the GEHR format (in relation to the latter, see: Validating Electronic Health Records Using Archetypes and XML, Tun Z., Bir L. J. and Goodchild A., CRC for Enterprise Distributed Systems (DSTC Pty Ltd), http://tititanium.dstc.edu.au/papers/acs2002.pdf). The metadata which can be stored in such data objects can be text or numbers and can contain references to the likewise stored image data, which can form the basis of a diagnosis. The diagnosis itself can be produced manually or automatically. The metadata, “Structured Report (SR) objects” in the DICOM standard, can be generated automatically by a Computer Aided Diagnosis (CAD) application or can be input manually by a medic in the form of a finding.

Even more than in many other areas of daily life, the health sector has particularly stringent demands on standards relating to the security and the format of patient data. These stringent demands are also relevant for obtaining and receiving the legally required licensing for technical medical equipment. They make it difficult for the standards to be frequently altered or alternated. The licensing problem, in particular, but also the necessary long-term availability of patient data require long retention of once recognized data formats and data processing systems.

To provide a format for medical data objects which is able to be used for as long a term as possible, there is a quite general syntax or a quite general data format available for metadata which is intended to be able to handle virtually all conceivable medical reports which can be produced on the basis of the underlying data object. This does not merely require all current conceivable medical reports to be able to be produced, but also virtually all conceivable reports in the coming years, on account of the longevity of standards in the health sector.

The image data and metadata are presented in reports using “templates” (the archetypes in GEHR standard), which define a particular format for particular questions using particular data from the patient record. By way of example, there is such a template for mammography examinations, another for cardiac catheter examinations etc. Since there are many different examinations, whose number will increase further in future, there will also be an increasing number of templates.

Since the metadata following a quite general syntax, humans are able to read them only with difficulty. If XML is chosen as the syntax, for example, data structures containing a large number of structuring and formatting commands in addition to the actual information are obtained. The large number of these commands indicates that the unpracticed reader, that is to say a medic, for example, can identify the relevant data only with difficulty. Instead, the medic, as a typical user of such data, much prefers the metadata to be presented in a form which humans can read, possibly together with associated image data. He would then like to be able to print this presentation in the form of a report, for example, and to forward it to another treating physician. The report then contains only the relevant values from the metadata, which are compiled and displayed in line with a mask, e.g. a Word mask.

The report mask's appearance can be known to the user, can follow a scheme, can be recognizable and can further simplify the legibility of the data. Such a report can contain not only the metadata but also the reference images, e.g. CT or X-ray pictures which clarify the diagnosis. In addition, besides information on the patient record, other components such as the logo and the address of the physician's clinic can also be contained in the report, and formal aspects such as the design of the letterhead can be covered.

Previously known standards for electronic patient records, such as the GEHR format, are based on a standard format for image data and metadata which needs to be observed by all users. To allow for the different requirements of individual users with regard to the structure of reports for presenting the image data and metadata, there are masks, “archetypes” in the GEHR standard, which can be developed and altered by the respective user, e.g. by a medic or by a clinic. The masks are knowledge objects, so to speak, which are used for report writing using the respective relevant data from the patient's record. The syntax of the masks then allows the relevant information to be read from the patient record and to be shown in suitable presentation formats such as value lists or tables. One possible example of a syntax which is suitable for this purpose and conforms to the patient record is XML.

Hence, although previous masks ensure good legibility for the user, they can be generated and altered only by users who have experience of handling the mask syntax. In addition, they do not ensure that there is any way of altering or inputting the patient records' data contained in the record.

### SUMMARY OF THE INVENTION

An aim of an embodiment of the invention is that, on the basis of a patient record with a firmly prescribed, standard data format, it should become possible to display the data in a wide variety of reports. Such reports can easily be generated or altered by a user who is generally inexperienced with regard to data syntax and is untrained, particularly with regard to the data syntax of the patient record, and which additionally allow the data contained to be input and altered.

An embodiment of the invention may achieve this aim by an apparatus and by a method.

An important concept of an embodiment of the invention is to store the patient record in data formats firmly prescribed by the manufacturer, on the one hand, and to display the data in variable presentation formats, on the other, by using mutually isolated, distributed data processing systems and methods. This allows optimum fulfillment of the different demands on standardized data management in the patient record, on the one hand, and on the greatest possible degree of user friendliness when the data are being handled by a user who is unpracticed in data syntax, on the other.

In one advantageous variant of an embodiment of the invention, for the report presentation of the data, a syntax for the report masks is chosen with which the inexperienced user is familiar from the outset. Suitable report presentations for this are based on programs in widespread use, such as Microsoft Word using the script language Visual Basic for Applications (VBA). These are familiar to a large number of users and provide even laymen with easily manageable ways of producing report formats incorporating electronically stored data. In addition, such programs are available virtually everywhere and the patient data can therefore be viewed virtually everywhere.

Another important concept of an embodiment of the invention involves choosing, on the basis of an electronic patient record in a standard data format, a report syntax which provides the average user not only with a simple way of editing the masks but also with the opportunity not just to display and to present data belonging to patient records but also to input them and to alter them. For this, the application on which the report syntax is based needs to have a bidirectional interface which it can use both to receive data from the electronic patient record and to write them or write them back to it. This makes it easier for the user to edit the data, since he can recover the data to be altered in the report context with which he is familiar and can associate them more easily and can use this report context as an input form at the same time.

In another advantageous variant of an embodiment of the invention, the content of data in the electronic patient record which have been input or altered by a user using reports is initially checked before the data are written back to the patient record. In this case, the content check can relate to the plausibility of the data per se by checking, by way of example, conditions such as consistency between the patient's sex and sex-specific diagnoses which have been input, but it can additionally also check the plausibility of the report data in their relationship with the data already present in the patient record. This makes it possible to avoid mistakes when inputting or altering patient data or when associating patient data with patient records.

Other advantageous variants of embodiments of the invention are also included.

### BRIEF DESCRIPTION OF THE DRAWINGS

The invention is described in more detail below using exemplary embodiments with reference to the figures, in which:

FIG. 1 shows a system architecture in accordance with an embodiment of the invention,

FIG. 2 shows a system architecture in accordance with an embodiment of the invention with automatic association of report forms,

FIG. 3 shows a distributed method in accordance with an embodiment of the invention.

### DETAILED DESCRIPTION OF THE PREFERRED EMBODIMENTS

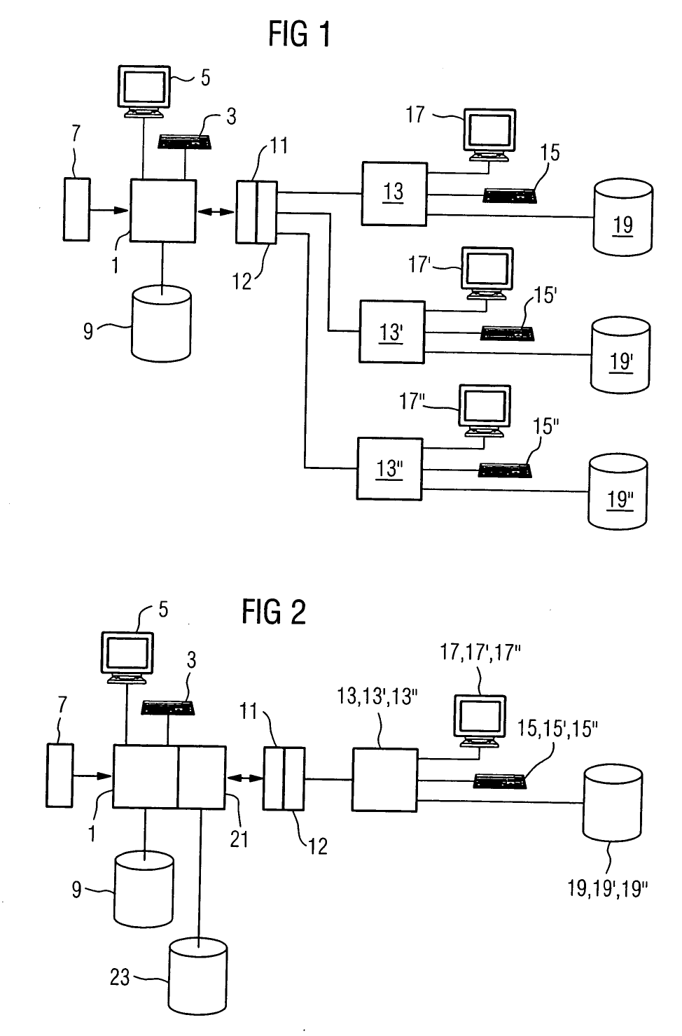

FIG. 1 shows a system for data processing in accordance with an embodiment of the invention. In this arrangement, a central component is a first data processing device 1 which has a keyboard 3 and a screen 5. The first data processing device 1 is used for displaying, editing and storing image data and metadata. It obtains the image data from a medical workstation for an imaging method, e.g. these can be CT, X-ray or NMR image data. The first data processing device 1 receives the image data via an image-source interface 7 and stores them in a data store 9. The image data can also be viewed and, if appropriate, can be subsequently edited graphically, and it is also possible for metadata in the form of text or numbers to be added.

The metadata can serve to identify the patient, and they can also include other personal details, notes relating to the image data or information relating to findings. Image data and metadata together form data objects whose format corresponds accordingly to a suitable, uniform standard for the format of electronic patient records. This can be the DICOM standard or GEHR format, for example.

The standard format is used particularly for efficient and widespread editability and accessibility of the data. It is firmly prescribed by the manufacturer according to the legal licensing. No attention is given in this context to simple displayability and, by way of example, the national language of the user. In this respect, the syntax of the data format is normally a basal programming language with a low level of development, e.g. XML. Accordingly, it is assumed that a user of the first data processing device 1 is trained to use this programming language, but may not need to have any expert medical knowledge.

The first data processing device 1 has access to an interface 11 via which it can transfer or receive data from data objects or complete data objects. The interface 11 comprises a data link together with a suitable communication protocol which permits the data to be transmitted between the first data processing device 1 and the other, second data processing devices 13, 13′, 13″. The interface 11 can operate on an Internet or Intranet basis, with telephone or mobile telephone radio support. It is also possible for the interface to be a logical interface within a computer. The second data processing devices 13, 13′, 13″ each have a keyboard 15, 15′, 15″ and a screen 17, 17′, 17″ for presenting and editing the data objects. These can be portable or permanently installed computers or medical workstations or other data processing devices. To receive the data or data objects, they access an interface 12 which can be connected to the interface 11. For this purpose, the interfaces 11, 12 are able to use the same communication protocol.

The second data processing devices 13, 13′, 13″ are used for presenting data from data objects for users who are medically trained, but may be untrained in the use of less highly developed programming languages such as those used for programming the data objects for the patient record. Presentation of the data by the second data processing devices 13, 13′, 13″ is optimized in terms of the legibility and clarity of the data. It is not firmly prescribed by the manufacturer by rather can be prescribed or altered by users themselves who are not experienced in programming language and data syntax. In addition, it should also be able to be configured differently according to the data contained in the presentation, e.g. certain configurations should be used for certain diagnosis types or for certain urgency types.

Since, in addition, the data objects are accessed from different locations by different users and with different aims, respective different forms of display should also be available for this purpose. To this end, the second data processing devices 13, 13′, 13″ each have dedicated mask memories 19, 19′, 19″ which contain report masks matched to the respective application for the purpose of displaying the data. In addition, generic report masks are available therein which allow clear presentation of patient data for which it has not been possible to find a suitable specific report mask. The generic report masks prescribed can then be displays of the data in tree structures or tables, for example.

The report masks are designed such that they display only the respective relevant data from the patient record in a form suitable for the respective diagnosis or for the respective user. Should all data be relevant for a presentation, all the data of a data object can also be displayed. Depending on the structure of the patient record, it can furthermore also be appropriate to display data from a plurality of data objects together. The form of display is intended to be able to be altered by the respective user, for example in order to be able to influence formal changes to the letterhead or aspects of the content of the display. The mask memories 19, 19′, 19″ therefore each contain dedicated report masks which can be created on the basis of a suitable report language and need only observe the data format of the data object interface 11. Since the report syntax should also be familiar to untrained users where possible, reports in Microsoft Word format are suitable for this, for example.

To be able to present data from the patient record which have been received via the interface 12, the reports incorporate data fields using a data application suitable for this purpose which also provides the unprofessional user with easy-to-handle design and editing options, e.g. Microsoft Visual Basic for Applications. This data application is able to display and also to alter the data. This makes it possible to provide the user with the option of not only presenting but also altering the data for the patient record, e.g. adding to or aligning findings. A storage thereof in the patient record, that is to say following transfer by the interfaces 11, 12 to the associated data objects in the data store 9, can be prompted after any change or whenever a work session has been closed, for example.

The concept of locally alterable report masks makes it possible to support any number of report masks and to add new report masks for needs which arise in the future. At the same time, the format of the actual database, the electronic patient record, remains undisturbed, and the database therefore continues at all times to be based on the specifications which governed its admission at that time. In other words, changes to the report masks do not result in its losing its license which is required for operating a technical medical appliance.

The system described comprises two components which are both able to process data autonomously. The two components can run on the same or separate computers. The only absolute necessity is interconnected interfaces 11, 12 which the two components can use to interchange data for the patient record.

The first component, the first data processing device 1, in this arrangement is an application which, by way of example, produces a medical workstation, i.e. it can display, receive, edit and send diagnostic data. In this context, it uses a recognized protocol, such as DICOM or GEHR, which supports the transfer and storage of metadata and image data. In addition, the first data processing device 1 ensures the observance of data security rules which cannot be influenced by the user. By way of example, by authenticating all data access operations, it ensures that not every user can read or modify all data, but rather only a user who is entitled to do so. In addition, it also ensures documentation of all data access operations in order to permit later reconstruction of read or write access operations by any users to any data objects.

Similarly to the dependence on the data formats of the patient records, the technical medical data is also dependent on the security components and on the fact that these cannot be altered by the user. He can neither change or deactivate the security requests for authentication nor can he influence or alter the contents of the documentation. Hence, the inaccessible implementation of the security components in the first data processing device 1 also helps to maintain the technical medical license for as long a term as possible.

The second component, the second data processing device 13, 13′, 13″, preferably supports a word processing application. This application is able to use a macrolanguage for the purpose of autonomously executing a program which can access the data in the data objects from the patient record. Instead of a word processing application, however, it is also possible to use a spreadsheet application, for example, in order to start arithmetic analysis of the patient data. The spreadsheet can ascertain statistical data, e.g. can generate the frequency of stages of illness, graphical displays of trends during the course of the illness, e.g. the evolution of the body temperature or frequency of attacks of tachycardia, or can create statistical graphs from the data from patient collectives. It is also possible to use all other data processing programs for office use, “office programs”, for the data processing.

When the user starts the second component, a particular report mask is loaded from a report mask memory 19, 19′, 19″ which contains initially empty data fields instead of data from the patient record. To enter values into the empty data fields, the macrolanguage of the office program accesses the interface 12 and fetches the necessary patient data therefrom. In the process, it also transfers the user data which are required for authentication and documentation. The patient data are added to the document at the appropriate points. The user can then use the respective office program to generate, store, print, send etc. reports and graphs.

If the user makes changes to the data which are present in the data record, that is to say to the values of the data in the data fields, these altered data can be transmitted back via the interfaces 11, 12. In addition, the user data for authentication and documentation are transmitted at the same time as the data are transmitted back, if appropriate. The interfaces 11, 12 thus operate bidirectionally. Data transmitted back are checked for plausibility before they are written to the data store 9 by the first data processing device 1. By way of example, it is possible to check whether the indication of a patient's weight comes within natural limits, whether findings which have been input conflict with the patient record available to date or whether sex-specific findings, such as pregnancy, have actually been indicated only for patients of the correct sex.

FIG. 2 shows a system in accordance with an embodiment of the invention in which the operation of the interface 11 has been complemented by a data switching device 21. Otherwise, the system shown in FIG. 2, together with all the references, is equivalent to that shown in FIG. 1. The data switching device 21 adds to the system a communication component which is registered on the first data processing device 1 as an available application. This application is available to the second data processing devices 13, 13′, 13″, or to the applications running thereon, for data access. It mediates between the applications and the data store 9 for the first data processing device 1 and the applications for the second data processing devices 13, 13′, 13″.

If the applications for the second data processing devices 13, 13′, 13″ are Microsoft-based applications, then the data switching device 21 is entered as an object in the “Running Object Table” (ROT). Microsoft applications can access the ROT and can ascertain whether the data switching device 21 is available. They can then access the functions of the data switching device 21 in order to request data objects for the patient record from the data store 9 or to store them in the data store 9.

The data switching device 21 accesses an association database 23 storing information about the association between particular types of patient data and report masks. The data switching device 21 first checks the type of the requested data object from the patient record, e.g. whether the data object contains diagnostically or therapeutically oriented patient data or on which diagnosis it is based, uses the information in the association database 23 to ascertain the name of the associated report mask, and transmits this name to the interface 11. Next, the data switching device 21 transmits the requested metadata or image data and makes them available to the requesting data processing device.

If appropriate, the selection of the name of the report mask can additionally be supported interactively by virtue of the user being asked via the connected interfaces 11, 12, by way of example, which office application or which report form the second data processing device 13, 13′, 13″ needs to use to process the data. In addition, other information from the first data processing device 1 or from the second data processing device 13, 13′, 13″ can go into the selection of the report mask.

If data need to be stored back to the patient record in the data store 9, the data switching device 21 undertakes checking of the data which are to be written back for their plausibility or consistency with the rest of the patient record. In addition, the data switching device 21 prompts storage of all access operations and operations for documentation purposes. These can also include access operations to the patient record which are not connected to the alteration of patient data. The documentation of the access operations and the other operations serves firstly for legally required documentation and can secondly assist a billing system.

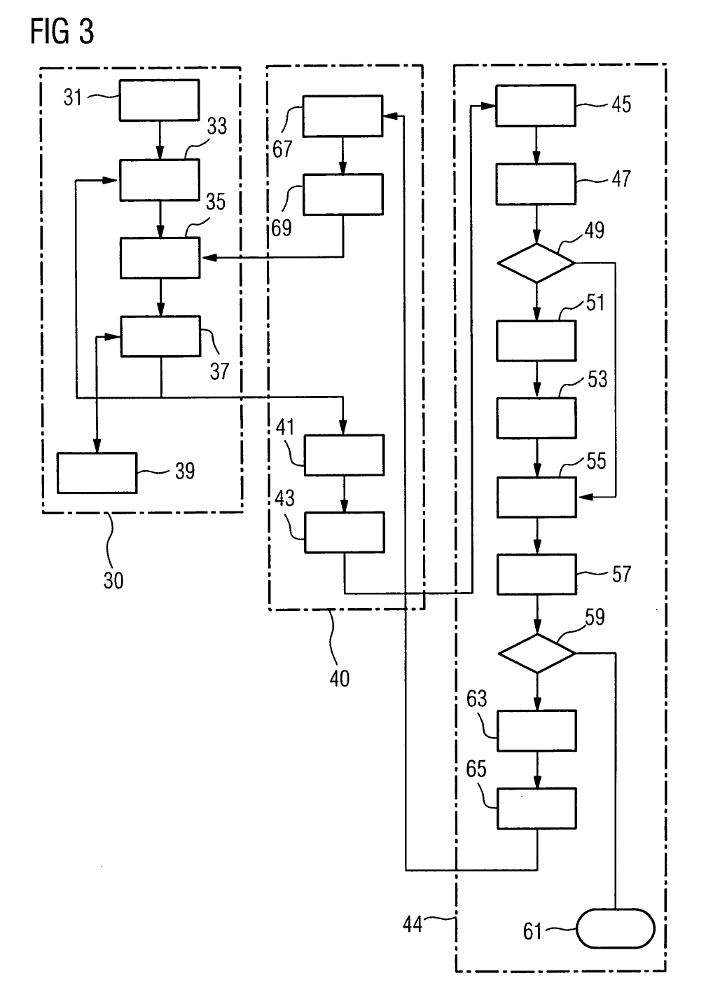

FIG. 3 shows the distributed method in accordance with an embodiment of the invention. The first method component 30 involves the data objects being generated or being received from a modality in method step 31. In step 33, the data objects can be viewed and edited, with no variable formats being available for viewing and editing. Instead, the application is tied to firmly prescribed formats which are defined within the framework of legally required licensing of the method. In step 35, the data objects are formatted in line with the licensing specifications for storage, and the formatted data objects are stored in step 37. The format of the data is part of the legal licensing and is firmly prescribed by the manufacturer. It cannot be influenced by the user.

Storage can take place only if the memory access can be authenticated by the user in step 39. Without successful authentication, the user cannot perform any write access and possibly any read access either to the data object memory. Storage of the data is also documented in connection with the authentication in step 39, which means that it is always possible to reconstruct at later times which user has accessed the data at what time and in what way. Authentication and documentation, like the prescription of data formats, are thus performed on the basis of the legal specifications and cannot be influenced by the user in any way, since any changes to these method steps could result in the loss of the licensing.

The data switching component 40 can send the data from the data objects to the second method component 44, so that they can be presented there in more readable and manageable data formats. Data access by the data switching component 40 is documented and authenticated, like any data access, in step 39, which is why information about the respective accessing user also needs to be interchanged. The data can be sent on request, according to particular distribution-list rules or when particular events occur. By way of example, a hospital can have the stipulation that new data from particular diagnostic examinations are automatically sent to the treating physician or that data are automatically transmitted to duty staff at emergency stations if data contents which are critical for the patient are detected.

Within the data switching component 40, the data are taken from the patient record in step 41 and are sent in a format which can be read by the report application provided for presentation. In addition, the type of data to be transmitted is checked in step 43 and a particular report mask suitable for displaying the data which are to be transmitted is allocated on the basis of the type of data. If it is not possible to ascertain a specific report mask, generic report masks are also available which have the clearest structure possible for displaying any data, e.g. a table structure or a tree structure. In addition, in step 43, the data content can also be checked to determine whether it points to a critical or otherwise special patient condition which necessitates automatic sending of the data to particular addressees, i.e. to emergency stations or to medical specialists in particular fields of expertise.

The data are transmitted to the second method component 44. Within this component, the report application used to present the data is started in step 45. In this case, the presentation does not need to adhere to any legal specifications, and it is thus also not prescribed by the manufacturer, but rather can be prescribed or altered by the user. The report application is an application which is as widely used as possible and with which as many users as possible are familiar, e.g. Microsoft Word. The report application first opens the report mask communicated by the data switching component 40. If no report mask has been communicated or if the report mask is not wanted, it is instead also possible to open a report mask which the user requires or which is set as standard. In addition, the data switching component 40 can transmit to the user, instead of a particular report mask, enquiries relating thereto in order to ascertain the report mask which is to be opened interactively.

In step 49, the user decides whether he wishes to use or alter the opened report mask or whether he wishes to create a new report mask. If he wants the latter, the report mask is edited in step 51 and is then stored in step 53.

In step 55, when the report mask has been edited or accepted, an application is started which allows data to be displayed by the data switching component 40 in the report mask. The application thus combines contents of the patient record with the previously chosen form of presentation for these contents. In this case, the combination with the presentation is made using commands from the application which are incorporated in the report mask. The application should therefore have the most easily manageable syntax possible which can also easily be learned by the layman so that he can easily make alterations to the report mask in respect of the illustrated contents as well. The application should be familiar to the unprofessional user for this purpose or should run in an application environment with which the user is familiar. Particularly in the case of the report application Microsoft Word, the use of Visual Basic for Applications is suitable. This macrolanguage has readable and comprehensible commands which can also be produced using the user interface without any special knowledge. It therefore becomes accessible at least to the interested user without any particular difficulty, and the user is able to generate and alter report masks, including the data fields which are to be incorporated, according to his own needs.

In step 57, the data from the patient record are presented in the report mask which has been opened. The user can store, print or send the presentation, e.g. a Word form or a spreadsheet graph.

In step 59, the user decides whether he wishes to change or input the displayed data from the patient record. If he does not wish to do so, the method is ended in the next step 61. If he does, the patient data are edited in step 63. To this end, the user can change, add to, delete or input the contents of the data fields in the presentation. This is done in the report application's user interface with which he is familiar, and also in the context familiar to him in which the report mask presents the data. In step 65, the altered data are stored. This can be done either automatically at particular intervals of time, whenever leaving a data field or upon a command from the user.

The stored data are transmitted to the data switching component 40, possibly with user data for authentication and documentation. The data switching component 40 is able to handle data from the report application, and receives these data in step 67. In step 69, the data are subjected to a plausibility check. This involves checking, inter alia, whether altered data are consistent with the rest of the data for the record and whether the alteration can be appropriate per se. By way of example, it is not possible to diagnose pregnancy for a male patient, or a patient cannot have halved his body weight within a few days. Data identified as being plausible are transmitted to the first method component 30, where they are formatted in step 35 according to the storage specifications for data objects, are stored back in step 37, and the data access is documented and authenticated in step 39.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A data processing system for processing medically relevant data objects including at least one of image data and metadata, comprising:
a first electronic data processing device for viewing and editing the data objects, the first electronic data processing device including,
a data store for storing the data objects, and
a first interface for outputting data objects; and
a second electronic data processing device for presenting data from data objects in medically relevant reports using report masks, the second electronic data processing device including,
a mask memory for storing the report masks, and
a second interface for receiving the data objects, wherein the first data processing device uses firmly prescribed data formats, unalterable by a user, to store, view and edit the data objects, wherein the second data processing device uses report masks, generatable and alterable by the user to present data from data objects, even without knowledge of the syntax of the data objects, and wherein the interfaces of the first and second data processing devices are connectable to one another for transfer of data objects from the first data processing device to the second data processing device.

2. The data processing system as claimed in claim 1, wherein the second data processing device stores report masks at least one of generated and altered by the user, in the mask memory.

3. The data processing system as claimed in claim 1, wherein the second data processing device uses report masks, generateable and alterable by the user without knowledge of the syntax of the data objects, in order for a user to edit data from data objects.

4. The data processing system as claimed in claim 1, wherein at least one of the interfaces includes a data switching device, having access to an association memory containing information about an association between data object types and report masks, and wherein the data switching device is adapted to ascertain the type of a data object transferred via the interface, compare the ascertained type with the content of the association memory and associate a report mask with the data object on the basis of the result of the comparison.

5. The data processing system as claimed in claim 1, wherein the interfaces on the first and second data processing devices, when innerconnected, are useable to transfer data belonging to data objects from the second data processing device to the first data processing device, and wherein data objects with user-edited data, transferred to the first data processing device via the interconnected interfaces, are stored in the data store.

6. The data processing system as claimed in claim 5, wherein content of user-edited data is checked, and the checked data are stored by the first data processing device only on the basis of the result of the check.

7. The data processing system as claimed in claim 1, wherein the first data processing device is for authenticating all access operations to data objects by users in a manner which the user cannot alter and documents them for later reconstruction.

8. A distributed method for processing medically relevant data objects, including at least one of image data and metadata, with a first component for at least one of viewing, editing and storing the data objects and with a second component for presenting data from the data objects, comprising:
using prescribed data formats in the first component, which are unalterable by a user, to at least one of store, view and edit the data objects;
using report masks in the second component, which are at least one of generateable and alterable by the user without knowledge of the syntax of the data objects, to present data from the data objects, wherein data objects are transferable from the first to the second component.

9. The distributed method as claimed in claim 8, wherein the second component stores report masks, at least one of generated and altered by the user, in a mask memory.

10. The distributed method as claimed in claim 8, wherein the second method component uses report masks for a user to edit data from the data objects.

11. The distributed method as claimed in claim 8, wherein a data switching component is provided for ascertaining the type of a data object transferred from the first to the second component, for comparing the ascertained type with the content of an association memory containing information about the association between data object types and report masks, and for associating a report mask with the data object on the basis of the result of this comparison.

12. The distributed method as claimed in claim 8, wherein data belonging to data objects is transferable from the second to the first component, and wherein the first component stores data objects with user-edited data, transferred to the first component, in a data store.

13. The distributed method as claimed in claim 12, wherein the content of user-edited data belonging to data objects is checked, and the user-edited data are stored by the first component only on the basis of the result of this check.

14. The distributed method as claimed in claim 8, wherein the first component authenticates all access operations to data objects by users in a manner which the user cannot alter and documents them so that they can be subsequently reconstructed.

15. The data processing system as claimed in claim 2, wherein the second data processing device uses report masks, generateable and alterable by the user without knowledge of the syntax of the data objects, in order for a user to edit data from data objects.

16. The data processing system as claimed in claim 1, wherein at least one of the interfaces includes data switching means, having access to an association memory containing information about an association between data object types and report masks, for ascertainin the type of a data object transferred via the interface, for comparing the ascertained type with the content of the association memory and for associating a report mask with the data object on the basis of the result of the comparison.

17. The data processing system as claimed in claim 4, wherein the interfaces on the first and second data processing devices, when innerconnected, are useable to transfer data belonging to data objects from the second data processing device to the first data processing device, and wherein data objects with user-edited data, transferred to the first data processing device via the interconnected interfaces, are stored in the data store.

18. The data processing system as claimed in claim 17, wherein content of user-edited data is checked, and the checked data are stored by the first data processing device only on the basis of the result of the check.

19. The distributed method of claim 8, wherein the second component is used to present data from the data objects in medically relevant reports using the report masks.

20. The distributed method as claimed in claim 9, wherein the second method component uses report masks for a user to edit data from the data objects.

21. The distributed method as claimed in claim 9, wherein a data switching component is provided for ascertaining the type of a data object transferred from the first to the second component, for comparing the ascertained type with the content of an association memory containing information about the association between data object types and report masks, and for associating a report mask with the data object on the basis of the result of this comparison.

22. The distributed method as claimed in claim 10, wherein a data switching component is provided for ascertaining the type of a data object transferred from the first to the second component, for comparing the ascertained type with the content of an association memory containing information about the association between data object types and report masks, and for associating a report mask with the data object on the basis of the result of this comparison.

23. A data processing system for processing medically relevant data objects including at least one of image data and metadata, comprising:
first electronic data processing means for viewing and editing the data objects, the first electronic data processing means including,
storage means for storing the data objects, and
first interfacing means for outputting data objects; and
a second electronic data processing means for presenting data from data objects in medically relevant reports using report masks, the second electronic data processing means including,
memory means for storing the report masks, and
second interfacing means for receiving the data objects, wherein the first data processing means uses firmly prescribed data formats, unalterable by a user, to store, view and edit the data objects, wherein the second data processing means uses report masks, generatable and alterable by the user to present data from data objects, even without knowledge of the syntax of the data objects, and wherein the interfacing means of the first and second data processing means are connectable to one another for transfer of data objects from the first data processing means to the second data processing means.

24. The data processing system as claimed in claim 23, wherein the second data processing means stores report masks at least one of generated and altered by the user, in the memory means.

25. The data processing system as claimed in claim 23, wherein the second data processing means uses report masks, generateable and alterable by the user without knowledge of the syntax of the data objects, in order for a user to edit data from data objects.

26. The data processing system as claimed in claim 23, wherein at least one of the interfacing means includes data switching means, having access to an association memory containing information about an association between data object types and report masks, for ascertaining the type of a data object transferred via the interface means, for comparing the ascertained type with the content of the association memory and for associating a report mask with the data object on the basis of the result of the comparison.

27. The data processing system as claimed in claim 23, wherein the interfacing means on the first and second data processing means, when innerconnected, are useable to transfer data belonging to data objects from the second data processing means to the first data processing means, and wherein data objects with user-edited data, transferred to the first data processing means via the interconnected interfaces, are stored in the storage means.

28. The data processing system as claimed in claim 27 wherein content of user-edited data is checked, and the checked data are stored by the first data processing means only on the basis of the result of the check.

29. The data processing system as claimed in claim 23, wherein the first data processing means is for authenticating all access operations to data objects by users in a manner which the user cannot alter and documents them for later reconstruction.
